(19) United States
(12) Patent Application Publication
(10) Pub. No.: US 2008/0202454 A1
(43) Pub. Date: Aug. 28, 2008

(54) Split-cycle engine with water injection

(75) Inventor: Jean-Pierre Pirault, Shoreham-by-SEA (GB)

Correspondence Address: FILDES & OUTLAND, P.C., 20916 MACK AVENUE, SUITE 2, GROSSE POINTE WOODS, MI, 48236, US

(73) Assignee: Scuderi Group. LLC.

(21) Appl. No.: 12/069,470

(22) Filed: Feb. 11, 2008

Related U.S. Application Data
(60) Provisional application No. 60/903,640, filed on Feb. 27, 2007.

(51) Int. Cl. F02B 75/18; F02B 47/02

(52) U.S. Cl. 123/58.8; 123/25 C

(57) ABSTRACT

A split-cycle water injection engine includes a crankshaft rotatable about a crankshaft axis. A power piston is slidably received within a power/expansion cylinder and operatively connected to the crankshaft. A compression piston is slidably received within a compression cylinder and operatively connected to the crankshaft. A crossover passage is operatively connected between the compression cylinder and the power/expansion cylinder and selectively operable to receive compressed air from the compression cylinder and to deliver compressed air to the power/expansion cylinder for use in transmitting power to the crankshaft during engine operation. Valves selectively control gas flow into and out of the compression and power cylinders. A water injector is associated with and adapted to inject water into at least one of the compression cylinders the crossover passage and the power cylinder during engine operation.

### CROSS REFERENCE TO RELATED APPLICATION

This application claims the benefit of U.S. Provisional Application No. 60/903,640, filed Feb. 27, 2007.

### TECHNICAL FIELD

This invention relates to split-cycle engines and, more particularly, to such engines incorporating water injection for improved power and/or operation.

### BACKGROUND OF THE INVENTION

For purposes of clarity, the following definition is offered for the term split-cycle engine as may be applied to engines disclosed in the prior art and as referred to in the present application.

A split-cycle engine as referred to herein comprises:

a crankshaft rotatable about a crankshaft axis;

a power piston slidably received within a power cylinder and operatively connected to the crankshaft such that the power piston reciprocates through a power (or expansion) stroke and an exhaust stroke during a single rotation of the crankshaft;

a compression piston slidably received within a compression cylinder and operatively connected to the crankshaft such that the compression piston reciprocates through an intake stroke and a compression stroke during a single rotation of the crankshaft; and

a gas passage interconnecting the power and compression cylinders, the gas passage including an inlet valve and an outlet (or crossover) valve defining a pressure chamber therebetween.

United States patents U.S. Pat. No. 6,543,225 B2, U.S. Pat. No. 6,609,371 B2 and U.S. Pat. No. 6,952,923 (Scuderi patents), all assigned to the assignee of the present invention, disclose examples of split-cycle internal combustion engines as herein defined. These patents contain an extensive list of United States and foreign patents and publications cited as background in the allowance of these patents. The term “split-cycle” has been used for these engines because they literally split the four strokes of a conventional pressure/volume Otto cycle (i.e., intake, compression, power and exhaust) over two dedicated cylinders: one cylinder dedicated to the high pressure compression stroke, and the other cylinder dedicated to the high pressure power stroke.

Considerable research has been recently devoted to air hybrid engines. The air hybrid needs only the addition of an air pressure reservoir added to an engine incorporating the functions of a compressor and an air motor, together with the functions of a conventional engine, for providing the hybrid system benefits. These functions include storing pressurized air during braking and using the pressurized air for driving the engine during subsequent starting and acceleration.

Water injection into cylinders of conventional four-stroke internal combustion engines has been applied in the past for knock control in supercharged engines, but is not known to have been used for improving brake thermal efficiency or brake power.

### SUMMARY OF THE INVENTION

The present invention results from computer modeling studies of the application of water or steam injection to a split cycle engine for increasing brake power output and/or efficiency. Possible results of detonation (knock) control and reduction of NOₓ emissions were also considered. Summarized conclusions of the study are as follows:

Water injection into the compressor cylinder is predicted to increase brake power and efficiency. Water injection into the crossover passage may have no power or efficiency benefits, but may significantly reduce NOₓ and detonation effects. It is assumed that any added water is heated externally using a form of waste heat.

Steam injection into the compressor cylinder is predicted to have neutral effects, but steam injection into the crossover passage should increase engine power and efficiency. It is assumed that any added steam is generated externally using waste heat.

Water injection into the expansion cylinder is predicted to significantly improve both brake power and efficiency if the injected water can be made to impinge on the piston or cylinder head in order to generate steam while cooling those parts of the engine.

The predictive methods did not simulate the additional benefits associated with improved detonation resistance and reduced NOₓ emissions which are well known for SI engines with water and steam injection, and which are very significant. Assumed water/steam injection quantities ranged ˜1-2 times the fuel injection quantity.

Another important assumption with all the predictions is that any injected water is able to evaporate instantly on entering the cylinder or crossover passage. This is practically unlikely, and the benefits of water injection will depend significantly on the speed at which water can be evaporated. The time constants of internal combustion engines are such that it can be difficult to achieve evaporation in the compression cylinder unless the water is present in a very fine droplet form, providing a large surface area, and is hopefully close to its boiling point.

While benefits of water or steam injection appear attractive, there are serious practical issues, notably added hardware complexity, water consumption, freezing protection, oil contamination and possibly corrosion. External steam generation would be a major hardware cost. On the other hand, the split cycle engine stands to gain more from water injection to the compressor than a 4-stroke engine, because the compressor work, and re-expansion losses, are greater than a 4-stroke engine. Although steam injection may be difficult in the expansion cylinder, it may be easier in the crossover passage and could help control crossover wall temperatures.

The summarized conclusions of the report led to the conception of several embodiments of split cycle engines using water injection. These include:

Split cycle engine with direct water injection into the compressor cylinder;

Split cycle engine with direct water injection into the crossover passage prior to the discharge of compressed air into the expansion cylinder;

Split cycle engine with direct steam injection into the crossover passage prior to the discharge of compressed air into the expansion cylinder;

Split cycle engine with direct water injection into the expansion cylinder;

Split cycle engine with direct steam injection into the expansion cylinder;

Split cycle air hybrid engine with direct water/steam injection into one of the compressor cylinder, the crossover passage and the expansion cylinder.

Additional variants and sub-groups are also contemplated.

These and other features and advantages of the invention will be more fully understood from the following detailed description of the invention taken together with the accompanying drawings.

### BRIEF DESCRIPTION OF THE DRAWINGS

FIG. 1 is a schematic diagram of an exemplary embodiment of prior split-cycle engine having a compression cylinder, a crossover passage and an expansion cylinder;

FIG. 2 is a view similar to FIG. 1 but showing a first embodiment of the present invention featuring water or steam injection directly into the compression cylinder;

FIG. 3 is a view similar to FIG. 1 but showing a second embodiment featuring water or steam injection directly into the crossover passage;

FIG. 4 is a view similar to FIG. 1 but showing a third embodiment featuring water or steam injection directly into the expansion cylinder;

FIG. 5 is a view similar to FIG. 1 but showing an air hybrid engine including a compressed air storage tank and featuring additional embodiments including water or steam injection into one or more of the compression cylinder, the crossover passage and the expansion cylinder;

FIG. 6A is a computer model for water/steam injection into the compressor cylinder;

FIG. 6B is a listing of item definitions for FIG. 6A;

FIG. 7A is a computer model for water/steam injection into the crossover passage;

FIG. 7B is a listing of item definitions for FIG. 7A;

FIG. 8 is a graph summarizing predictions for water and steam injection into the compression cylinder;

FIG. 9 is a graph summarizing predictions for water and steam injection into the crossover passage;

FIG. 10A is a computer model for water injection into the expansion cylinder;

FIG. 10B is a listing of item definitions for FIG. 10A;

FIG. 11 is a graph of cylinder pressure vs. crank angle with and without water injection from Table A1; and

FIG. 12 is a graph of bulk cylinder temperatures with water injection.

### DETAILED DESCRIPTION OF THE INVENTION

### I. Overview

The Scuderi Group LLC commissioned the Southwest Research Institute® (SwRI®) of San Antonio, Tex. to perform a Computerized Study. The Study involved constructing computer models used in determining predicted effects on operation of a split-cycle four stroke engine of the direct injection of water and/or steam into the compression cylinder, the crossover passage or the expansion cylinder of the engine. The Computerized Study resulted in the present invention described herein through exemplary embodiments pertaining to a split-cycle engine.

### II. Glossary

The following glossary of acronyms and definitions of terms used herein is provided for reference.
ATDC: After Top Dead Center;
Auto-ignition: uncontrolled ignition of part of the air/fuel mixture prior to controlled ignition initiated by the spark plug;
Bar: unit of pressure, 1 bar=0.1 N/mm²;
Baseline: GT Power model status established in U.S. Pat. No. 6,952,923 and used as a baseline for later comparisons;
Brake Mean Effective Pressure (BMEP): the average (mean) pressure which, if imposed on the pistons uniformly throughout one engine cycle, would produce the measured (brake) power output. Essentially, the engine torque normalized by the engine displacement;
Brake Power: engine power measured at the output shaft, for example, by a dynamometer (brake);
Brake Thermal Efficiency (BTE) or Brake Efficiency: percentage of the fuel energy that is converted to mechanical energy, as measured at the engine output shaft;
CI engines: compression ignition (e.g. diesel) engines;
Combustion Event: the process of combusting fuel, typically in the expansion chamber of an engine, the duration of which is typically measured in degrees crank angle (CA);
Compressor Work: the energy expended by the crankshaft in moving the compressor piston;
Crank Angle (CA): the angle of rotation of the crankshaft throw, typically referred to its position when aligned with the cylinder bore;
Enthalpy: heat content;
Expander Work: the energy expended by the expansion piston in moving the crankshaft;
Full Load: the maximum torque that an engine can produce at a given speed. Also refers to the characteristic of the engine along a family of these points across an engine speed range;
GT Power: engine simulation tool from Gamma Technologies Inc;
Injection Period: the duration of the fuel or water injection event, usually measured in degrees of crankshaft revolution;
Knock Limited: A condition at which any further increase in torque would cause the engine to knock (uncontrolled combustion with a very steep pressure rise, initiated by auto-ignition and potentially damaging);
Latent Heat of Vaporization: the amount of energy required for a material to undergo a change of phase between liquid and gas without a change in temperature;
NOₓ: oxides of nitrogen;
Pumping Losses: frictional losses associated with pumping of gas through an engine;
SI engines: Spark Ignition (e.g. Otto) engines;
Start of Injection Timing (SOI): position of the crankshaft at which fuel or water begins to be injected, usually expressed in crank angle degrees relative to Top Dead Canter;
Stoichiometric: the ratio of air to fuel at which complete combustion of the fuel occurs. For gasoline, the stoichiometric ratio is 14.7:1 by weight; and
Vapor Fraction: fraction of a fluid that is vapor as opposed to liquid.

### III. Embodiments of Split-Cycle Engines Resulting from the Computerized Study

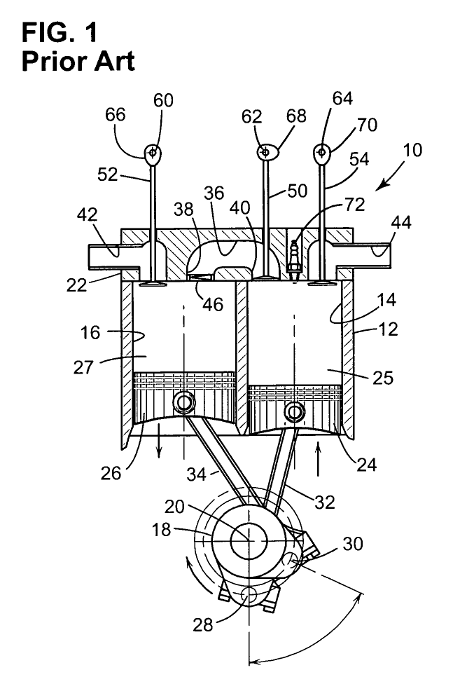

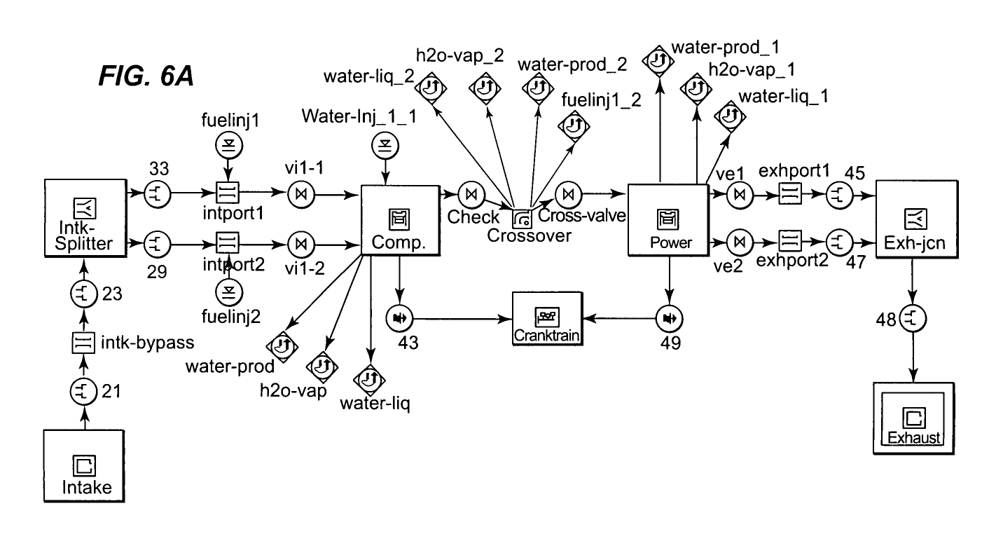

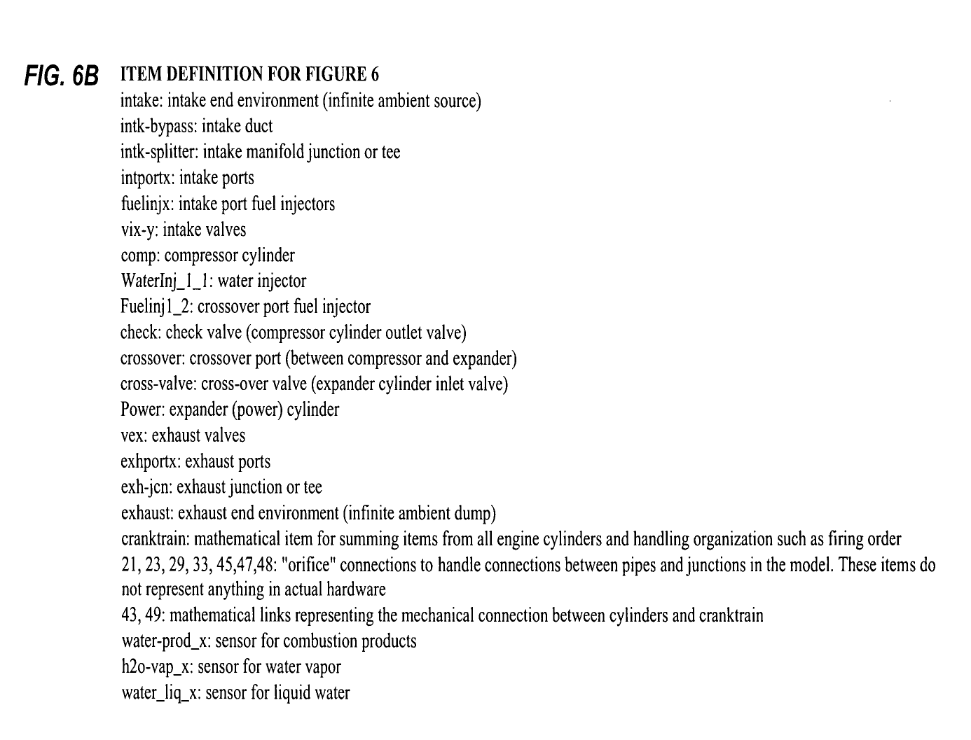

Referring first to FIG. 1 of the drawings in detail, numeral 10 generally indicates an exemplary embodiment of a split cycle four stroke internal combustion engine as disclosed in FIG. 6 of the prior U.S. Pat. No. 6,952,923 B2.

As shown, the engine includes an engine block 12 having a first cylinder 14 and an adjacent second cylinder 16 extending therethrough. A crankshaft 18 is journaled in the block 12 for rotation about a crankshaft axis 20, extending perpendicular to the plane of the drawing. Upper ends of the cylinders 14, 16 are closed by a cylinder head 22.

The first and second cylinders 14, 16 define internal bearing surfaces in which are received for reciprocation a first power piston 24 and a second compression piston 26, respectively. The cylinder head 22, the power piston 24 and the first cylinder 14 define a variable volume combustion chamber 25 in the power cylinder 14. The cylinder head 22, the compression piston 26 and the second cylinder 16 define a variable volume compression chamber 27 in the compression cylinder 16.

The crankshaft 18 includes axially displaced and angularly offset first and second crank throws 28, 30, having a phase angle 31 therebetween. The first crank throw 28 is pivotally joined by a first connecting rod 32 to the first power piston 24 and the second crank throw 30 is pivotally joined by a second connecting rod 34 to the second compression piston 26 to reciprocate the pistons in their cylinders in timed relation determined by the angular offset of their crank throws and the geometric relationships of the cylinders, crank and pistons.

Alternative mechanisms for relating the motion and timing of the pistons may be utilized if desired. The timing may be similar to, or varied as desired from, the disclosures of the Scuderi patents. The rotational direction of the crankshaft and the relative motions of the pistons near their bottom dead center (BDC) positions are indicated by the arrows associated in the drawings with their corresponding components.

The cylinder head 22 includes any of various passages, ports and valves suitable for accomplishing the desired purposes of the split-cycle engine 10. In the illustrated embodiment, the cylinder head includes a gas crossover passage 36 interconnecting the first and second cylinders 14, 16. The crossover passage includes an inlet port 38 opening into the closed end of the second cylinder 16 and an outlet port 40 opening into the closed end of the first cylinder 14. The second cylinder 16 also connects with a conventional intake port 42 and the first cylinder 14 also connects with a conventional exhaust port 44.

Valves in the cylinder head 22 include an inlet check valve 46 and three cam actuated poppet valves, an outlet valve (or crossover valve) 50, a second cylinder intake valve 52, and a first cylinder exhaust valve 54. The check valve 46 allows only one way compressed air flow into the reservoir inlet port 38 from the second (compression) cylinder 16. The reservoir outlet valve 50 is opened to allow high pressure air flow from the crossover passage 36 into the first (power) cylinder 14. The poppet valves 50, 52, 54 may be actuated by any suitable devices, such as camshafts 60, 62, 64 having cam lobes 66, 68, 70 respectively engaging the valves 50, 52, 54 for actuating the valves.

A spark plug 72 is also mounted in the cylinder head with electrodes extending into the combustion chamber 25 for igniting air-fuel charges at precise times by an ignition control, not shown. It should be understood that the engine may be made as a diesel engine and be operated without a spark plug if desired. Moreover, the engine 10 may be designed to operate on any fuel suitable for reciprocating piston engines in general, such as hydrogen or natural gas.

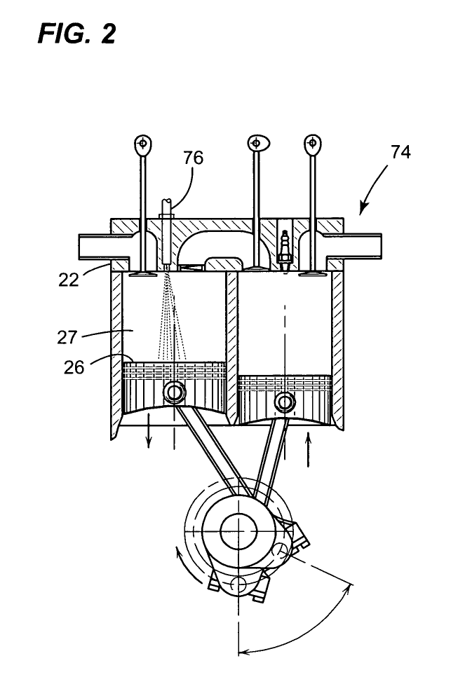

The manner of operation of the engine of FIG. 1 is described in detail in U.S. Pat. No. 6,952,923 and other Scuderi patents describing modified or improved embodiments. FIGS. 2-5 of the drawings illustrate concepts by which the exemplary split cycle engine of FIG. 1 and other similar engines may be modified to utilize water or steam injection in accordance with the conclusions of the Computerized Study from which the present invention resulted.

FIG. 2 illustrates an engine 74 disclosing a first embodiment of the invention wherein the basic structure of the engine is based on the embodiment of FIG. 1 and wherein like numerals indicate like parts. Engine 74 differs from the prior disclosure in the addition of a water or steam injection system for injecting heated liquid or vaporized (steam) water directly into the compression chamber of the engine.

FIG. 2 shows, as an example, a water or steam injector 76 mounted in the engine cylinder head 22 and aimed to spray preheated water or steam into the compression chamber 27, preferably during the compression stroke. The water may be directed in a fine spray directly toward the compressor piston 26, which may assist in cooling the piston and vaporizing the water. Improved power and efficiency, as well as knock limiting and reduction of NOₓ emissions may be obtained by this arrangement.

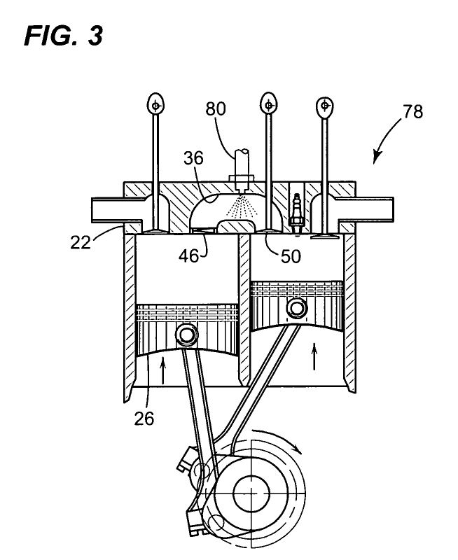

In FIG. 3, an engine 78 similar to FIG. 1 is provided with a water or steam injector 80 mounted in the cylinder head 22. The injector sprays preheated water or steam in a fine spray directly into the crossover passage 36 during a period wherein both the inlet check valve 46 and the outlet or crossover valve 50 are closed.

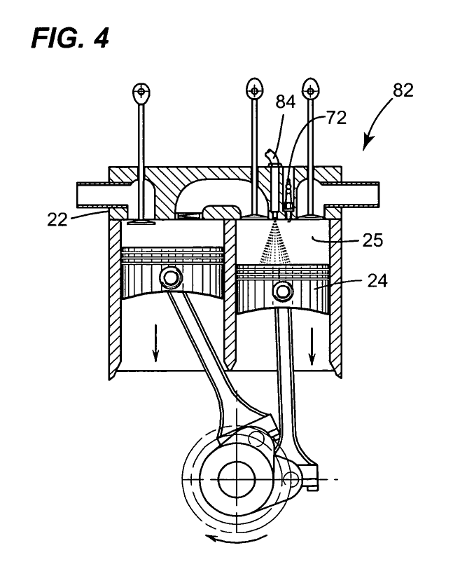

FIG. 4 shows an engine 82 similar to FIG. 1 provided with a water or steam injector 84 mounted in the cylinder head 22 adjacent the spark plug 72. The injector sprays preheated water or steam directly into the combustion chamber 25. The water spray may be injected at any time during engine operation except during the engine exhaust stroke unless only cooling of the chamber surfaces is desired.

To avoid interference with combustion, water injection after the start of combustion appears desirable. Delay of water injection until after the power piston 24 has reached 30, 50 or 90 degrees crank angle ATDC, or when combustion is at least 30, 50 or 90 percent complete, may provide increasing degrees of power and efficiency improvement.

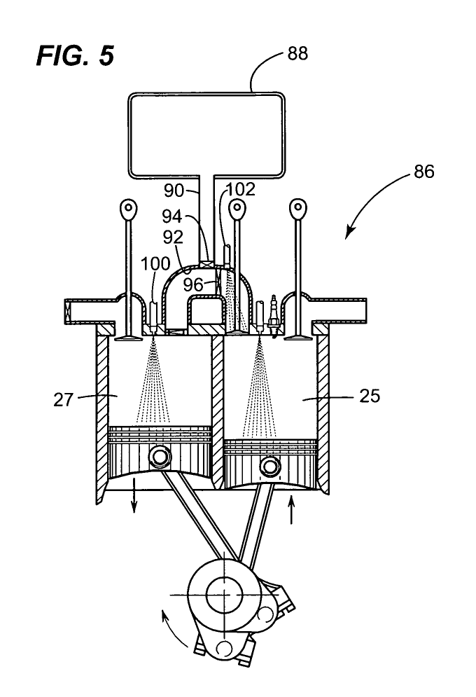

FIG. 5 illustrates the manner in which water/steam injection may be applied to an air hybrid split-cycle engine indicated by numeral 86. Engine 86 is generally similar to engine 10 but differs in the addition of an air pressure storage chamber or tank 88. The tank is connected by a duct 90 to the crossover passage 92. Solenoid valves 94, 96 control air flow between the crossover passage and the tank, and between the crossover passage and the combustion/expansion chamber 25.

In accordance with the invention, separate water/steam injectors 100, 102, 104 are mounted in the cylinder head and connected to spray water/steam directly into the compression chamber 27, the crossover passage 92 and the combustion chamber 25, respectively. The injectors may be operated as desired together or separately under varying engine operating conditions to obtain the desired effectiveness for each condition. Modified embodiments of the engine could also be provided using only one of the three water/steam injection locations as development finds to be most beneficial.

### IV. Computerized Study

1.0 Use of Water or Steam Injection with the Scuderi Split Cycle Engine

### 1.1 Executive Summary

GTPower computer models have been used to examine and predict the potential performance and fuel efficiency benefits of water or steam injection into the compressor, crossover passage and expander elements of the Scuderi Split Cycle (SSC) engine at 4000 rpm/full load, with certain assumptions for the water or steam injection conditions, but excluding significant water evaporation time, NOₓ and detonation aspects. Summarized conclusions are as follows.

Water injection into the compressor cylinder is predicted to increase brake power and efficiency, but water injection into the crossover passage has no benefits, other than potential NOₓ and detonation effects, that could be significant. It is assumed that any added water is preheated externally using some form of waste heat.

Steam injection into the compressor cylinder is predicted to have neutral effects, but steam injection into the crossover passage should increase engine power and efficiency. It is assumed that any added steam is generated externally using waste heat.

Water injection into the expansion cylinder is predicted to significantly improve both brake power and efficiency if the injected water can be made to impinge on the piston or cylinder head in order to generate steam while cooling those parts of the engine.

The predictive methods did not simulate the additional benefits associated with improved detonation resistance and reduced NOₓ emissions which are well known for SI engines with water and steam injection, and which are very significant. Assumed water/steam injection quantities ranged ˜1-2 times the fuel injection quantity.

Another important assumption with all the predictions is that the any injected water is able to evaporate instantly on entering the cylinder or crossover passage. This is practically unlikely, and the benefits of water injection will depend significantly on the speed at which water can be evaporated. The time constants of internal combustion engines is such that it can be difficult to achieve evaporation in the compression cylinder unless the water is present in a very fine droplet form, providing a large surface area, and is hopefully close to its boiling point.

While benefits of water or steam injection appear attractive, there are serious practical issues, notably added hardware complexity, water consumption, freezing protection, oil contamination and possibly corrosion. External steam generation would be a major hardware cost. On the other hand, the SSC stands to gain more from water injection to the compressor than a 4-stroke engine, because the compressor work, and re-expansion losses, are greater than a 4-stroke engine. Although steam injection may be difficult in the expansion cylinder, it may be easier in the crossover passage and could help control crossover wall temperatures.

### 1.2 Main Elements of Work

1.2.1 Water & Steam Injection into Compressor Cylinder and Crossover Passage

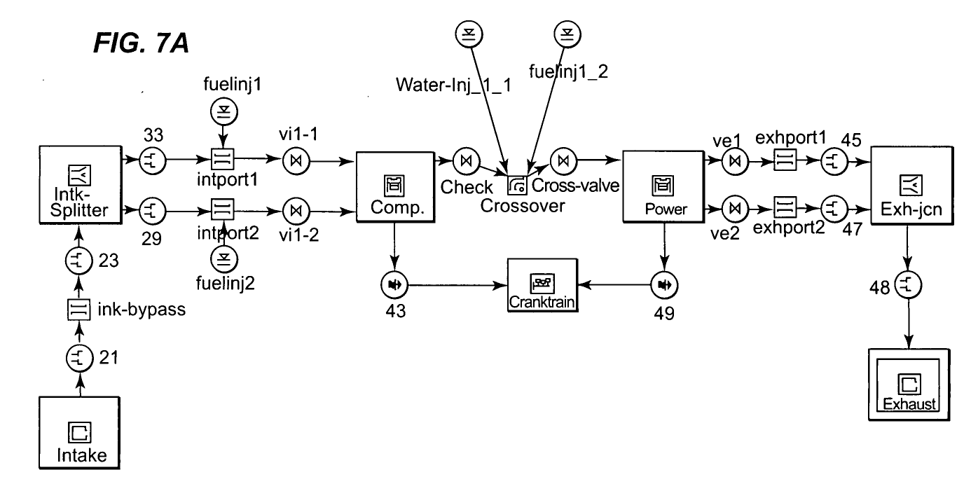

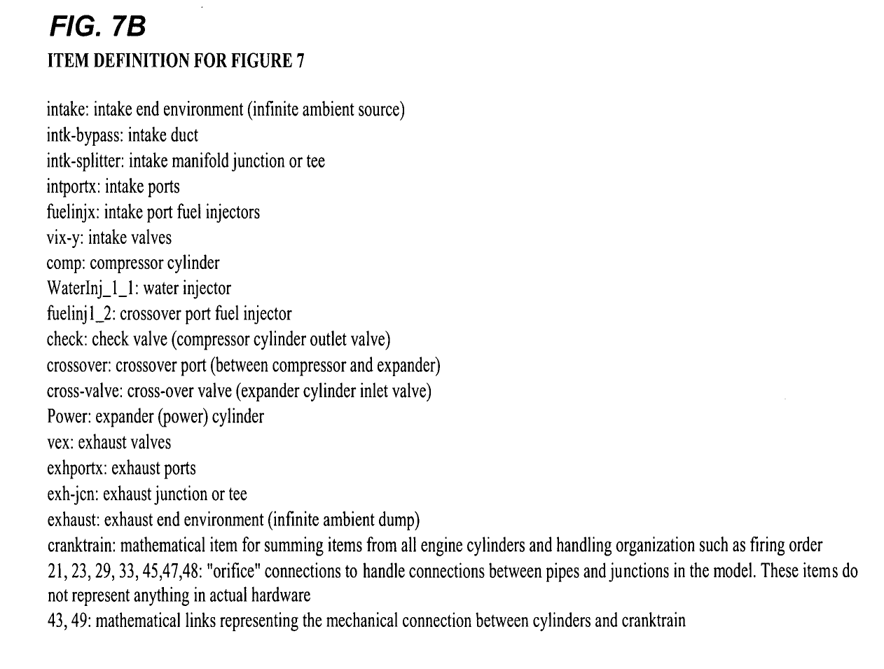

Water and/or steam injection is modelled with an injector inserted into the relevant part of the engine, i.e. into the compressor (FIG. 6) or into the crossover passage (FIG. 7).

Either water or steam may be injected at the prevailing pressure conditions associated with the engine component. Variables include water/steam temperature, quantity, injection timing and water/steam composition at the instant of injection; the GTPower model can also track the water and steam species.

Water injection assumes a selectable percentage of the water can be instantaneously evaporated to steam if the downstream temperature and pressure conditions will support steam, the energy for this coming from the working fluid into which the water is injected. The remaining (unevaporated) percentage of the water remains as water in the non-combustion parts of the engine (compressor and crossover), but vaporizes during combustion in the expander. However, any water injected after combustion (in the expander) will remain as water, unless a vapor fraction is specified.

For steam injection, the evaporating energy is externally supplied at the pressure conditions prevailing, so this would depend on a source of waste heat.

Summarized predictions from these models are now described.

### Results

The effects/benefits of water/vapor and steam injection are very different for the injection into the compressor versus injection into the crossover passage.

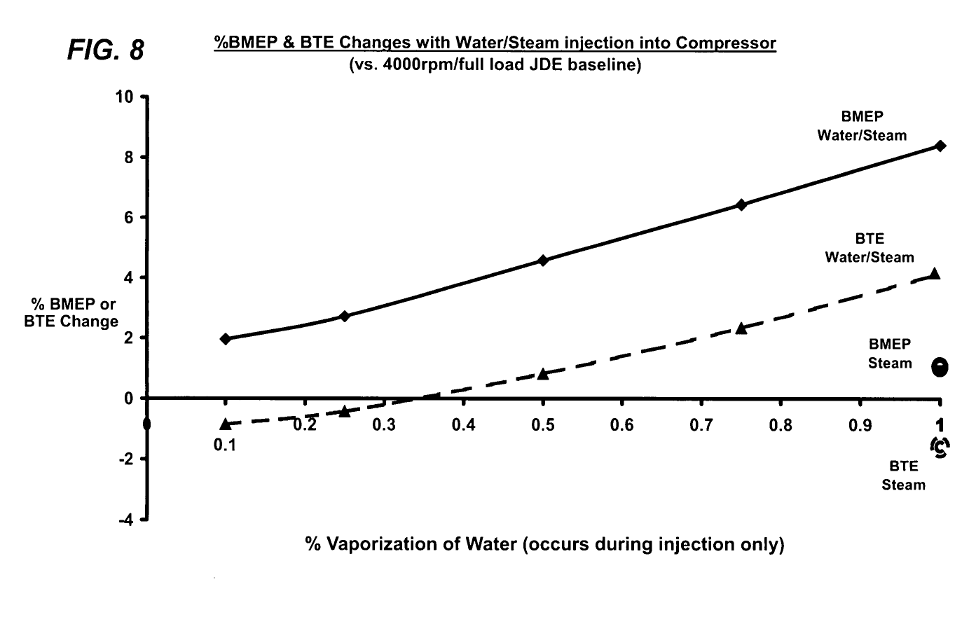

Water injection into the compressor, with vaporization, results in improved power output and brake efficiency with increasing degrees of vaporization. The power and efficiency improvements (FIG. 8) are due to a combination of reduced compressor work, reduced heat losses in the expander due to the lower cycle temperatures, and an increase in mass flow associated with the injected water, which is approximately equal to the fuel mass.

Steam injection into the compressor (single points in FIG. 8) has an almost neutral effect on power and efficiency, primarily because increased compressor pumping losses offset the gains in work output and reduced heat losses from the expansion cylinder.

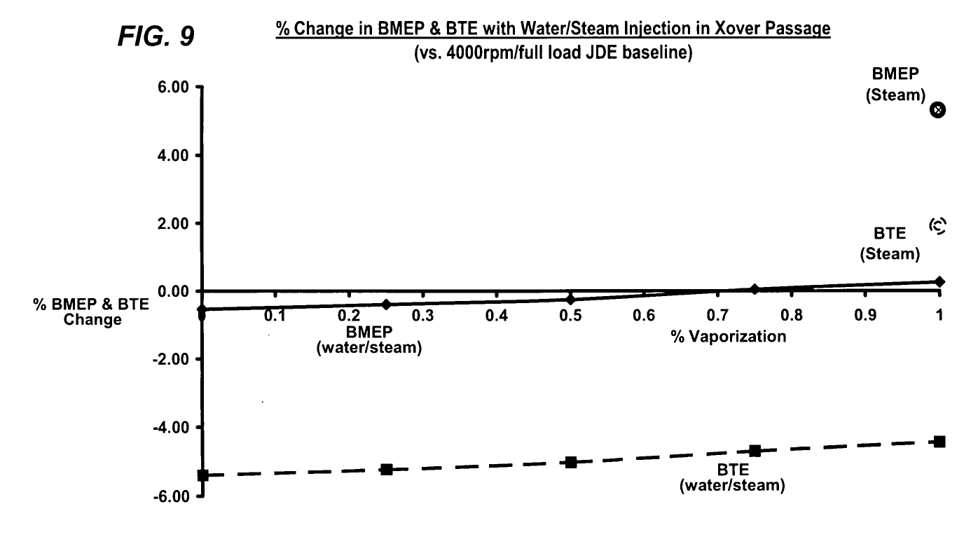

Conversely, steam injection (single points in FIG. 9) into the crossover passage increases the power and efficiency of the SSC engine, as this steam has negligible effect on the compressor work and simply adds to the expander work (FIG. 9) by virtue of higher pressures.

Water injection into the crossover passage, on the other hand, has an almost neutral effect on power but significantly reduces the brake thermal efficiency, both of these effects being because the water is not significantly reducing compressor work, but does reduce the expander work by reducing the crossover passage pressure, this effect more than offsetting the benefits of reduced heat losses in the expansion cylinder.

Although this GTPower model has no NOₓ or autoignition models, it is almost certain that both water and steam injection into the compressor cylinder and crossover passage would have significant benefits on NOₓ reduction, and performance improvements if the SSC engine is knock limited.

1.2.2 Water & Steam Injection into the Expansion Cylinder

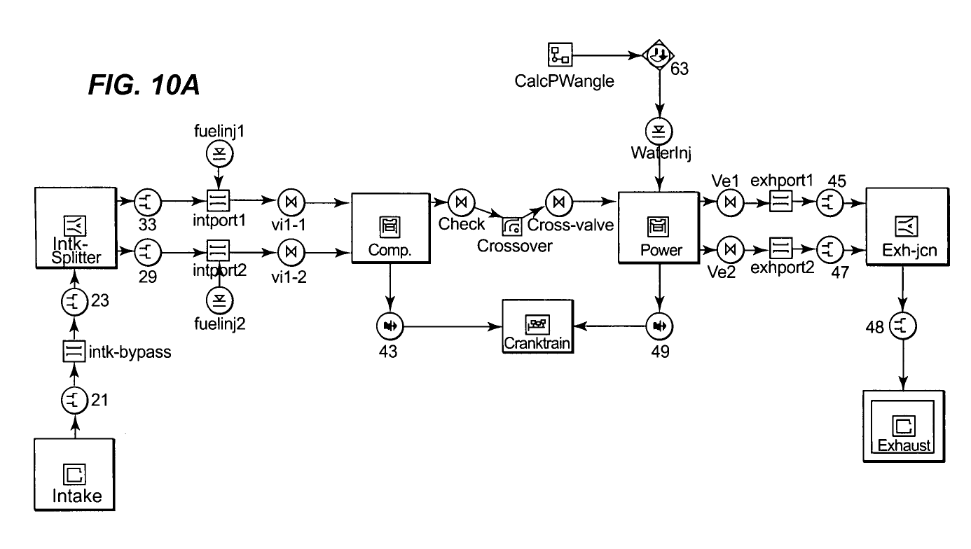

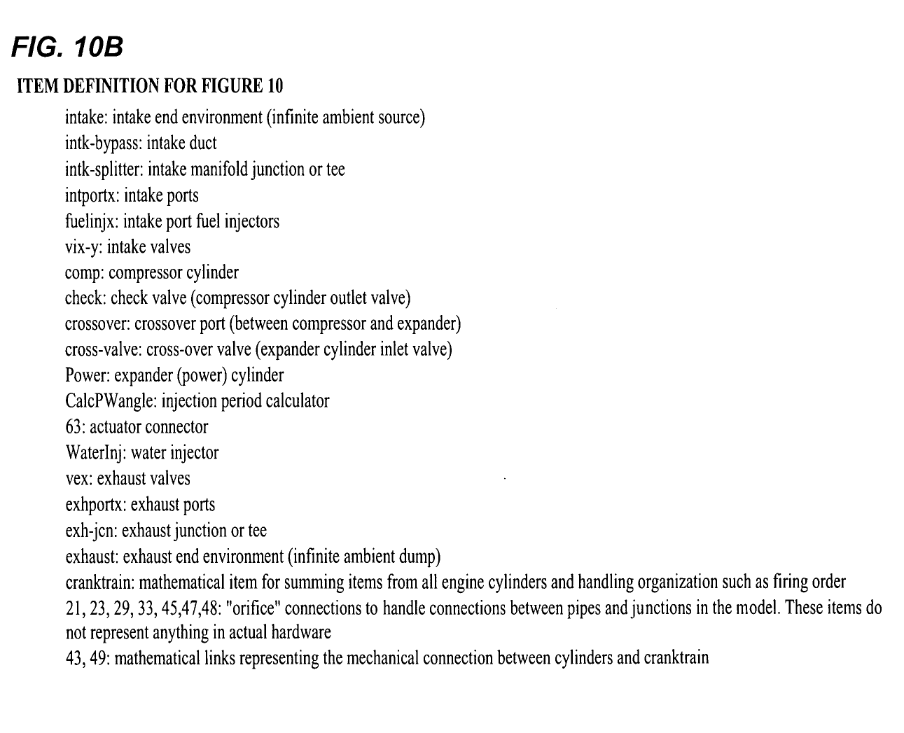

The model (FIG. 10) has been used to simulate the concept of heat extraction by steam generation from the piston at 4000 rpm/full load, assuming the piston crown to be at 600° K (327° C.), with water vaporizing to superheated steam at 600° K after impact with the piston. Start of “water” injection (SOI) timings of 50 and 90° ATDC were explored, so that the water/steam does not interfere with combustion which ceases ˜50° ATDC, and after evaporation, the steam is superheated by heat transfer from the fuel air/mixture, which as an example is at ˜2000° K (1727° C.) at 90° ATDC.

The model assumes that the heat of vaporization of the water is either provided from the piston, i.e. water is injected, the water is vaporized by the piston, and the heat required to take the vapor from the evaporated steam conditions to a superheat that matches the in-cylinder charge temperature is extracted from the in-cylinder burnt charge. The heat transfer from the piston is adjusted, manually, to reduce its heat loss by an amount equivalent to the heat of vaporization of the water. This might physically be achieved by impinging the water spray onto the piston, without any heat transfer from the cylinder fuel-air mixture; more heat could be extracted by spraying the water onto other internal surfaces of the cylinder, e.g. the exhaust valves and cylinder head.

Steam injection rates, e.g. ˜116% & 232% of fuel flow, have been selected so that the heat of evaporation of the injected water approximately matches the cyclic heat input from combustion into the piston (or multiples, allowing for heat transfer from the cylinder head). Feedpump water injection work is included. Water injection pressures match those of the prevailing cylinder pressures occurring during the injection period.

The change in piston temperature arising from the water impingement/steam latent heat of evaporation is approximately assessed by assuming that the latent heat of evaporation only cools a portion of the piston, the remainder of the piston being at a less critical component temperature. The cooled portion of the piston is arbitrarily assumed to be 10% of the bare piston mass, but can be readily changed.

Predictions are summarized in Table A1 (Steam 1-2 versus baseline) and indicate that the water injection with subsequent evaporation to steam by heat transfer from the piston can improve brake power and brake thermal efficiency by 13-18%.

TABLE A1
Effects of Steam Injection on Brake
Performance and Efficiency at 4000 RPM/Full load

| Attribute/Case | Base | Steam 1 | Steam 2 |
|---|---|---|---|
| Injection Period (deg ATDC) | NA | 50-70 | 50-90 |
| % water/fuel | 0 | 116 | 232 |
| % water/(fuel & air) | 0 | 6.91 | 12.92 |
| Water inj. Temp. (deg C.) | NA | 327 | 327 |
| Power Increase (%) | NA | 13.34 | 17.90 |
| Efficiency Increase (%) | NA | 13.65 | 18.19 |
| Temp. reduction of piston (deg C.) | NA | 2.50 | 5.00 |

The 50° ATDC start of injection timing (SOI) is selected to provide a favorable tradeoff between expansion ratio (higher with earlier SOI) and heat transfer from the burning/burned gases.

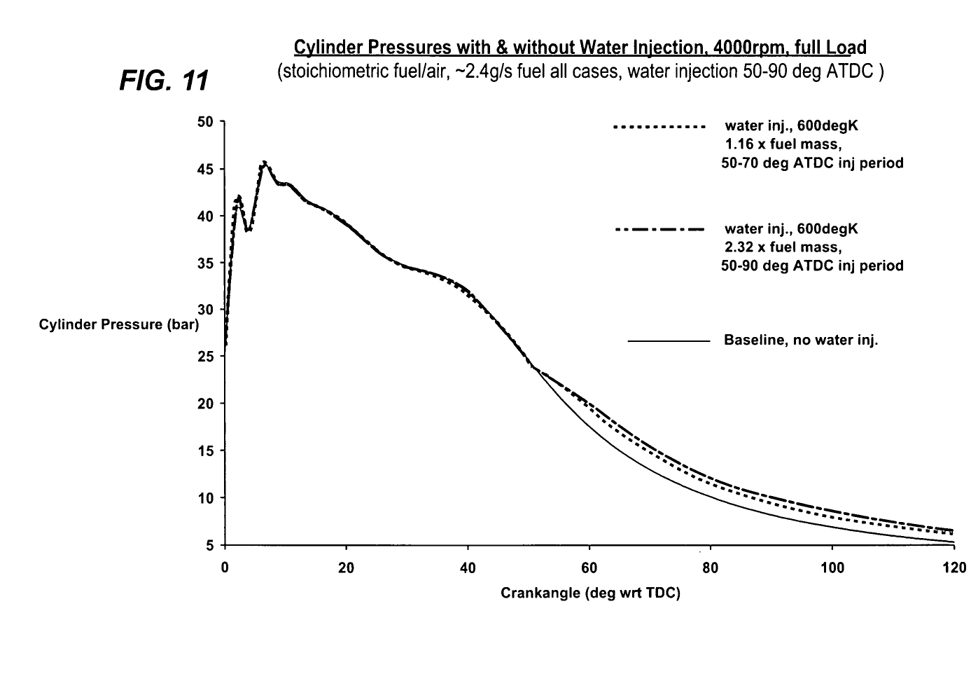

The cylinder pressure and temperature diagrams (FIGS. 11 & 12) indicate that cylinder pressure rises with steam generation, but the bulk cylinder temperature initially increases, then decreases with piston expansion.

It may at first sight be puzzling that bulk pressure can increase while bulk temperature reduces. The suggested explanation is that additional (cooler) mass is being added to the initial cylinder contents during the water injection period and this reduces the temperature of the mixture, but this must be set-off against the addition of the evaporative pressure element of the steam enthalpy.

### Piston Cooling

Table A1 indicates estimated maximum 2.5-5.0° C. reduction in 10% of the bare piston weight, assumed to be that area in contact with the water impingement, i.e., probably the piston crown. If heat of evaporation of the steam is drawn from a larger portion of the piston mass, the piston temperature reduction would be proportionally reduced. These temperature reduction estimates are very simplified and only provide a coarse guide of the potential temperature reductions.

The water injection/steam evaporation can be equally applied to the cylinder head to cool the exhaust valve heads.

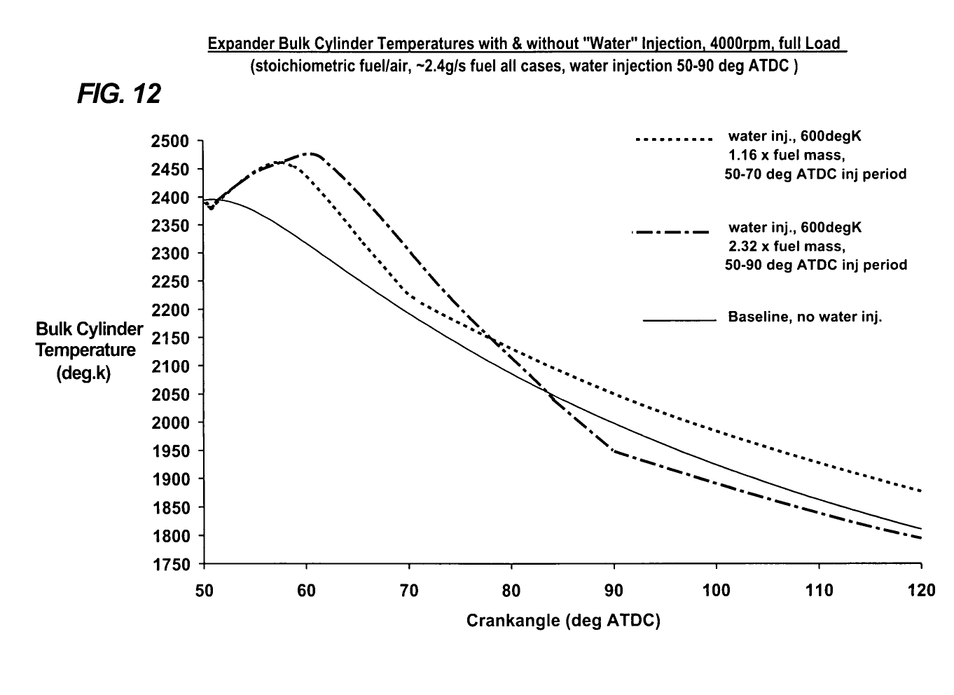

Bulk cylinder temperatures (FIG. 12) are a tradeoff of the increased cylinder mass and the effects of heat exchange between the steam (at ˜600° K) and the post combustion gases (˜at 1800-2400° K).

Although the invention has been described by reference to certain specific embodiments, it should be understood that numerous changes may be made within the spirit and scope of the inventive concepts disclosed. Accordingly, it is intended that the invention not be limited to the described embodiments, but that it have the full scope defined by the language of the following claims.

What is claimed is:

1. A split-cycle water injection engine comprising:
a crankshaft rotatable about a crankshaft axis;
a power piston slidably received within a power/expansion cylinder and operatively connected to the crankshaft such that the power piston reciprocates through an expansion stroke and an exhaust stroke during a single rotation of the crankshaft;
a compression piston slidably received within a compression cylinder and operatively connected to the crankshaft such that the compression piston reciprocates through an intake stroke and a compression stroke during a single rotation of the crankshaft;
a crossover passage operatively connected between the compression cylinder and the power/expansion cylinder and selectively operable to receive compressed air from the compression cylinder and to deliver compressed air to the power/expansion cylinder for use in transmitting power to the crankshaft during engine operation;
valves selectively controlling gas flow into and out of the compression and power cylinders; and
a water injector associated with and adapted to inject water into at least one of the compression cylinder, the crossover passage and the power cylinder during engine operation.

2. An engine as in claim 1 wherein the water injector is adapted to inject water in a form of heated liquid or steam.

3. An engine as in claim 2 wherein the water injector is associated with the compressor cylinder.

4. An engine as in claim 2 wherein the water injector is associated with the crossover passage.

5. An engine as in claim 2 wherein the water injector is associated with the power/expansion cylinder.

6. An engine as in claim 5 wherein the water is injected into the power/expansion cylinder after the beginning of combustion in the cylinder.

7. An engine as in claim 6 wherein the water is injected after at least 30% of the combustion event has occurred.

8. An engine as in claim 7 wherein the water is injected after at least 50% of the combustion event has occurred.

9. An engine as in claim 8 wherein. the water is injected after at least 90% of the combustion event has occurred.

10. An engine as in claim 5 wherein the water injection begins when the power piston reaches at least 30 degrees ATDC on the expansion stroke.

11. An engine as in claim 5 wherein the water injection begins when the power piston reaches at least 50 degrees ATDC on the expansion stroke.

12. An engine as in claim 5 wherein the water injection begins when the power piston reaches at least 90 degrees ATDC on the expansion stroke.

13. An engine as in claim 1 wherein the engine is a split-cycle air-hybrid engine and further includes:
an air reservoir operatively connected to the crossover passage between the compression cylinder and the power/expansion cylinder and selectively operable to receive compressed air from the compression cylinder and to deliver compressed air to the power/expansion cylinder for use in transmitting power to the crankshaft during engine operation, the valves selectively controlling gas flow into and out of the compression and power cylinders and the air reservoir.
